(19) United States
(12) Patent Application Publication
(10) Pub. No.: US 2008/0258543 A9
(43) Pub. Date: Oct. 23, 2008

(54) Method and device for carrying out a braking process

(75) Inventor: Stephan Reichle, Ispringen (DE)

Correspondence Address: Davidson, Davidson & Kappel, LLC, 485 7th Avenue, 14th Floor, New York, NY, 10018, US

(73) Assignee: DaimlerChrysler AG, Stuttgart (DE)

(21) Appl. No.: 10/580,666

(22) PCT Filed: Nov. 25, 2004
(86) PCT No.: PCT/EP04/13364

§ 371 Date: May 26, 2006

(30) Foreign Application Priority Data
Nov. 26, 2003 (DE) 103 55 218.9

(51) Int. Cl. B60T 8/18

(52) U.S. Cl. 303/9.69

(57) ABSTRACT

The invention relates to a method and a device for carrying out a braking process. A deceleration variable (zₛₒₗₗ) which describes the desired vehicle deceleration (zₛₒₗₗ) is reduced when the driving state of the vehicle during the braking process meets a first state condition, and increased again when the driving state of the vehicle meets a second state condition. The first state condition and/or the second state condition depend here on the front axle compression travel (s_{VA}) and/or on the rear axle compression travel (s_{HA}).

The invention relates to a method and a device for carrying out a braking process, a deceleration variable which describes the desired vehicle deceleration being reduced when the state of the vehicle during the braking process meets a first state condition, and the deceleration variable being increased again when the state of the vehicle meets a second state condition.

The method and the device are used to increase the comfort for the vehicle occupants at the end of a braking process by reducing the jolt to the vehicle as a result of pitching movements when the stationary state is reached.

Such a method and such a device are known from EP 0 537 874 A1. During a braking process, the braking force is adjusted down to a minimum value just before the stationary state of the vehicle is reached. The first state condition is thus met by the fact that the vehicle travels at a very low speed just before the stationary state of the vehicle. For this reason, the deceleration variable—here the braking force—is reduced. As soon as the stationary state of the vehicle has been detected, which constitutes the second state condition being met, the braking force is suddenly increased in order to keep the vehicle in the stationary state. Starting from the described prior art, the object of the present invention is to improve further the method and device for carrying out the braking process and to increase the comfort for the vehicle occupants.

This object is achieved according to the invention by means of the features of patent claim 1 and of patent claim 6.

At least one of the two state conditions depends on the front axle compression travel and/or on the rear axle compression travel. As a result the time at which the deceleration variable is reduced or increased again can be matched more precisely to the actual pitching movement of the vehicle.

Advantageous developments of the subject matter of the invention emerge from the dependent patent claims.

It is advantageous if the first state condition and/or the second state condition depend on the longitudinal velocity of the vehicle at the time of the start of the braking process. Alternatively or additionally, the first and/or second state conditions can depend on the deceleration variable. This measure ensures that the time when the deceleration variable is influenced is matched to the specific circumstances of the braking process which is occurring. As a result, a further increase in comfort is achieved.

In one advantageous embodiment, the fact that the first and/or second state conditions have been met is determined by reference to a predefined characteristic diagram. This constitutes a measure which is easy to implement in order to check the state conditions.

It is also advantageous if the reduction in the deceleration variable when the first state condition is met is carried out in such a way that the deceleration variable has a continuous profile or a profile which can be differentiated over time. This ensures the comfort of the vehicle occupants when the deceleration variable is influenced.

An exemplary embodiment of the method according to the invention and of the device according to the invention will be explained below in more detail by reference to the drawing, in which:

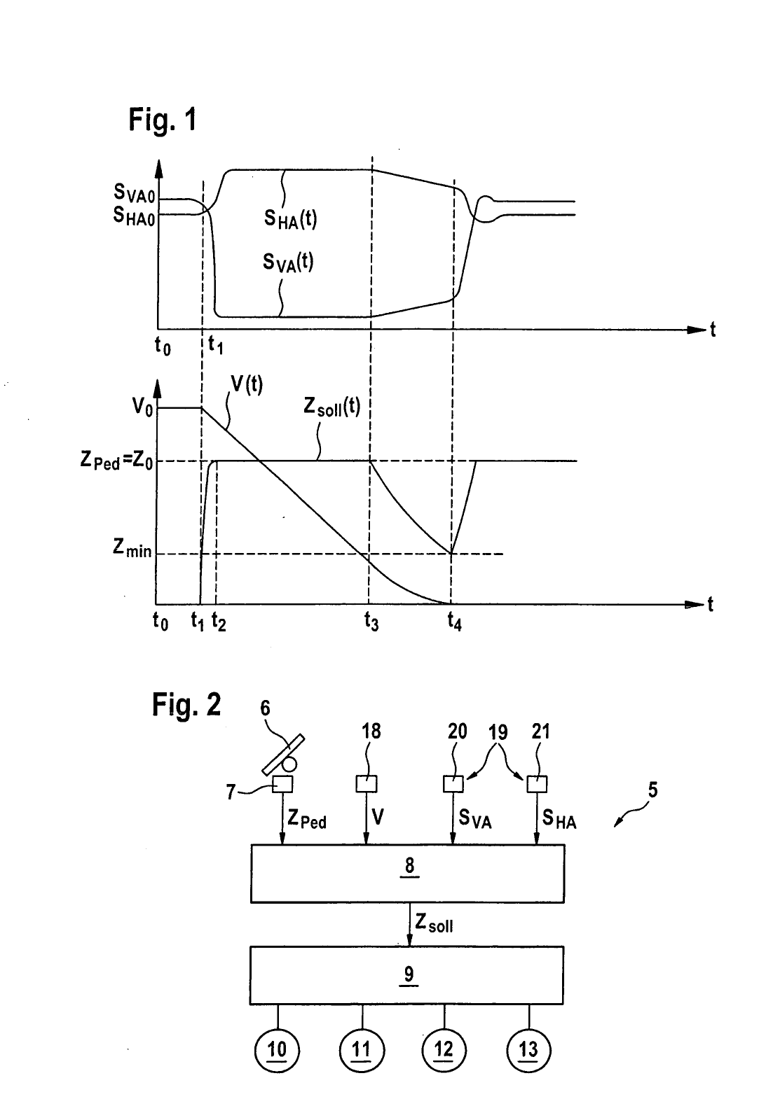

FIG. 1 is a first diagram with an exemplary profile of the front axle compression travel and of the rear axle compression travel as a function of time, and a second diagram with the exemplary profile of the longitudinal velocity of the vehicle and the desired vehicle deceleration as a function of time, and

FIG. 2 shows an exemplary embodiment of a device for carrying out a braking process as a block circuit diagram.

FIG. 2 shows a brake device 5 which is used to carry out a braking process of a vehicle (no longer illustrated). By means of a brake pedal 6, the driver of the vehicle can predefine a deceleration request which is sensed by means of a brake pedal sensor 7, and the requested deceleration variable z_{ped} is transmitted to deceleration determining means 8. The deceleration determining means 8 are used to determine a deceleration variable which describes a desired vehicle deceleration and is formed by the desired vehicle deceleration zₛₒₗₗ in the present exemplary embodiment. The desired vehicle deceleration zₛₒₗₗ is transmitted to brake actuating means 9 which actuate the wheel brake devices 10, 11, 12, 13 at the front and rear axles of the vehicle in order to set the predefined desired vehicle deceleration zₛₒₗₗ.

In the preferred exemplary embodiment according to FIG. 2 of the brake device 5, further vehicle parameters and/or driving state parameters which are used to determine the desired vehicle deceleration zₛₒₗₗ are transmitted to the deceleration determining means 8. The longitudinal velocity v of the vehicle is sensed by means of a velocity sensor 18 and passed on to the deceleration determining means 8. Furthermore, according to the example a spring travel sensor array 19 with a front axle compression travel sensor 20 and a rear axle compression travel sensor 21 is provided, said spring travel sensor array 19 sensing the front axle compression travel s_{VA} and the rear axle compression travel s_{HA} and transmitting them to the deceleration determining means 8 by means of corresponding signals.

The deceleration determining means 8 determine the desired vehicle deceleration zₛₒₗₗ by means of the input signals in such a way that the jolt which can be felt by the vehicle occupants at the end of a braking process as a result of pitching movements of the vehicle is reduced or avoided. For this purpose, the deceleration variable which describes the desired vehicle deceleration zₛₒₗₗ and which according to the example is formed by the desired vehicle deceleration zₛₒₗₗ itself is reduced in absolute value according to a predefined time profile when the driving state of the vehicle during the braking process meets a first state condition.

The checking for the fact that the first state condition is met is carried out in the exemplary embodiment in the deceleration determining means 8 by means of the longitudinal velocity v, the front axle compression travel s_{VA}, the rear axle compression travel s_{HA} and the deceleration which is requested by the driver by means of the brake pedal 6. In the exemplary embodiment described here, input parameters have been used in driving trials to determine empirically which values these parameters have to adopt for the first state condition to be met. In a modification of the described exemplary embodiment it is also possible to use only the compression travel at the front axle or at the rear axle for the checking of the state condition. Further vehicle parameters or driving state parameters such as the mass of the vehicle, the wheelbase, the distribution of the axle load or the like can also be used in the determination of whether the first state condition is met.

In contrast to the described embodiment, it is also possible to use a mathematical model such as, for example, a filter or a mathematical function, for checking whether the first state condition is met, instead of the stored, empirically determined characteristic diagram.

FIG. 1 illustrates the profile of a braking process by way of example. The first diagram shows the time profile of the front axle compression travel s_{VA} and of the rear axle compression travel s_{HA}. In the second diagram below it, the time profile of the longitudinal velocity v of the vehicle and of the desired vehicle deceleration zₛₒₗₗ are shown. At a first time t₀, the front axle compression travel is sᵥₐ=Sᵥₐ₀ and the rear axle compression travel is s_{HA}=s_{HA0}. The vehicle is traveling at the longitudinal velocity v=v₀ at this first time t₀. At a second time t₁, the driver activates the brake pedal 6. The desired vehicle deceleration zₛₒₗₗ which is determined in the deceleration determining means 8 from the requested vehicle deceleration z_{ped}=z₀ increases steeply starting from the second time t₁, reaches the requested value z_{ped}=z₀ at a third time t₂ and subsequently has an approximately constant profile. The longitudinal velocity v reduces from the second time t₁ and has an approximately linear profile from the third time t₂ owing to the desired vehicle deceleration zₛₒₗₗ which has been assumed to be constant. Owing to the dynamic axle load distribution caused by the deceleration of the vehicle, the value of the front axle compression travel s_{VA} drops after the second time t₁, which corresponds to compression travel of the front axle springs. In contrast to this, the value of the rear axle compression travel s_{HA} increases, which corresponds to spring extension of the rear axle springs. As long as an approximately constant vehicle deceleration is present during the braking process, the values of the two spring compression signals remain approximately constant.

Owing to the longitudinal velocity v=v₀ which is present at the start of the braking process at the second time t₁, the current desired vehicle deceleration zₛₒₗₗ which corresponds to the requested deceleration z_{ped}, the front axle compression travel s_{VA} and the rear axle compression travel s_{HA}, the fact that the first state condition is met is determined at a fourth time t₃ by reference to the stored characteristic diagram. The desired vehicle deceleration zₛₒₗₗ which is determined by the deceleration determining means 8 is reduced from this fourth time t₃ up to a predefined minimum deceleration value zₘᵢₙ according to a predefined time profile. This predefined time profile may be, for example, an e-function-like profile. Of course, any other desired time profile could also be used as a predefined time function for reducing the desired vehicle deceleration zₛₒₗₗ. It is comfortable for the vehicle occupants in this context if the desired vehicle deceleration zₛₒₗₗ at the time when the first state condition is met—at the fourth time t₃ here—has a continuous profile or a profile which can be differentiated.

The reduction in the desired vehicle deceleration zₛₒₗₗ at the fourth time t₃ causes the springs at the front axle to experience a certain amount of spring extension so that the front axle compression travel s_{VA} increases somewhat. At the same time, the springs at the rear axle experience a certain degree of spring compression, as a result of which the rear axle compression travel s_{HA} is reduced somewhat.

If the driving state during the further course of the braking process then meets the predefined second state condition, the desired vehicle deceleration zₛₒₗₗ is increased again. In the exemplary embodiment in question here, the second state condition is met when the longitudinal velocity v of the vehicle is approximately equal to zero, that is to say when the vehicle has come to a standstill. In the second diagram according to FIG. 1, this is the case at a fifth time t₄. The fact that this second state condition is met causes the deceleration determining means 8 to increase the desired vehicle longitudinal deceleration zₛₒₗₗ again to the requested vehicle deceleration z_{ped}. Since this increase in the desired vehicle deceleration zₛₒₗₗ takes place after the stationary state of the vehicle has been reached, the increase can be carried out within a very short period of time without a loss of comfort for the vehicle occupants, as a result of which the time profile of the desired vehicle deceleration zₛₒₗₗ is given a very steep rising edge. When the second state condition is fulfilled—at the fifth time t₄ here—a jump function in the desired vehicle deceleration could even be predefined here by the deceleration means 8.

As is shown in FIG. 1, such a time profile of the desired vehicle deceleration zₛₒₗₗ ensures that both the front axle compression travel s_{VA} and the rear axle compression travel s_{HA} have only a slight degree of overshooting in the time profile and subsequently assume their initial values again after the fifth time t₄ has been reached, that is to say after the stationary state of the vehicle has been reached. The jolt which can be felt by the vehicle occupants is significantly reduced by this, resulting in a significantly improved level of driving comfort for a braking process as far as the stationary state.

The present method and the present device can be used in particular in the field of utility vehicles since the front axle compression travel s_{VA} and/or the rear axle compression travel s_{HA} are determined in any case in said field so that there is then no need to provide an additional sensor system on the vehicle.

1-6. (canceled)

7. A method for carrying out a braking process, in order to reduce a jolt to a vehicle as a result of pitching movements when a stationary state is reached, the method comprising:
reducing a deceleration variable describing a desired vehicle deceleration when a driving state of the vehicle during the braking process meets a first state condition; and
increasing the deceleration variable again when the driving state of the vehicle meets a second state condition;
at least one of the first state condition and the second state condition being a function of a front axle compression travel and/or the rear axle compression travel.

8. The method as claimed in claim 7 wherein at least one of the first state condition and the second state condition are a function of a longitudinal velocity of the vehicle at a time of a start of the braking process.

9. The method as claimed in claim 7 wherein at least one of the first state condition and the second state condition are a function of a requested deceleration variable.

10. The method as claimed in claim 7 further comprising determining if at least one of the first state condition and the second state condition has been met by reference to a predefined characteristic diagram.

11. The method as claimed in claim 7 wherein the reduction in the deceleration variable when the first state condition is met is carried out in such a way that the deceleration variable has a continuous profile or a profile differentiable over time.

12. A device for carrying out a braking process in order to reduce a jolt to a vehicle as a result of pitching movements when a stationary state is reached comprising:
deceleration determining means for determining a deceleration variable describing a desired vehicle deceleration, the deceleration determining means reducing the deceleration variable when a driving state of the vehicle during the braking process meets a first state condition and increasing the deceleration variable again when the driving state of the vehicle meets a second state condition; and
a compression travel sensor array for sensing a front axle compression travel and/or rear axle compression travel and transmitting a front axle compression travel signal and/or a rear axle compression travel signal for checking the first state condition and/or the second state condition to the deceleration determining means.

13. A device for carrying out a braking process in order to reduce a jolt to a vehicle as a result of pitching movements when a stationary state is reached comprising:
a deceleration determiner for determining a deceleration variable describing a desired vehicle deceleration, the deceleration determiner reducing the deceleration variable when a driving state of the vehicle during the braking process meets a first state condition and increasing the deceleration variable again when the driving state of the vehicle meets a second state condition; and
a compression travel sensor array for sensing a front axle compression travel and/or rear axle compression travel and transmitting a front axle compression travel signal and/or a rear axle compression travel signal for checking the first state condition and/or the second state condition to the deceleration determiner.
